(19) United States
(12) Patent Application Publication
(10) Pub. No.: US 2006/0089903 A1
(43) Pub. Date: Apr. 27, 2006

(54) Multi-party-transaction information access system

(75) Inventors: Tyler Ford, Tucson, AZ (US); Douglas M. Olson, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(73) Assignee: Breakthrough Tools, LLC

(21) Appl. No.: 10/971,880

(22) Filed: Oct. 22, 2004

(51) Int. Cl. G06Q 40/00

(52) U.S. Cl. 705/38

(57) ABSTRACT

A multi-party transaction management system includes a web-page server that includes a multi-party transaction web-page. This web-page allows authorized users to enter contact information and transaction information that may only be viewed by the authorized users. The transaction information includes transaction process steps, electronic word-processing documents, and notes. Authorized users may send notifications to other authorized users.

### BACKGROUND OF THE INVENTION

1. Field of the Invention

This invention is related in general to data access. In particular, the invention consists of a system for providing multi-party access to transactional information.

2. Description of the Prior Art

Transactions in residential and commercial mortgages and real-estate are often complex proceedings involving numerous parties, each with his particular interest and responsibility. For example, a typical sale of real-estate can involve a selling and listing real-estate agent, purchaser, a seller, and an escrow agent. A real-estate agent may introduce the purchaser to the seller and coordinate the purchase transaction. If the purchase is financed, additional parties include the borrower (usually the purchaser), lender (mortgage company), and possibly a mortgage broker. The lender or mortgage broker may be represented by a loan officer.

Communication between the multiple parties can be time-consuming and fraught with mistakes and misunderstandings. For example, a typical loan for the purchase of real-estate may require a loan officer to take 30-40 telephone calls over the course of the transaction from the buyer, real-estate agents, and escrow company. If the average telephone conversation lasts about 5 minutes, approximately 2 hours of a loan-officer's time per transaction is dedicated to simply answering the telephone. Accordingly, it would be advantageous to have a system for drastically reducing the number of telephone calls between transaction parties.

Each telephone conversation is also an opportunity for a mistake or misunderstanding. If a loan-officer confuses which particular transaction a caller is referring to, the loan-officer may provide the caller with wrong information. Or, the caller could misinterpret what the loan-officer actually says. Therefore, it would be advantageous to have a system for limiting communications to a specific transaction and for providing information that is reproducible and verifiable. It would also be advantageous to have a mechanism for distributing uniform information to each party.

Another problem involving multi-party transactions is that each party must contact numerous other parties to obtain all the information necessary to complete a transaction. For example, a purchaser must maintain communications with the real-estate agents or seller, escrow agent, and the loan officer. A seller must maintain communications with the real-estate agent or purchaser and the escrow agent. A loan officer must stay in contact with the purchaser, real-estate agent, and escrow officer. These numerous contacts require maintaining multiple addresses, phone numbers, and email addresses. It would be advantageous to maintain a single point of contact for all of these communications.

Another transactional issue arises when parties are not be available when other parties need information. For example, a real-estate agent may be out of town or on vacation when a seller wants a progress report or a loan-officer may be in a meeting when a purchaser is ready to receive and fill out a form. Accordingly, it would be advantageous to place information in a forum where it is always available, even when the posting party is away from work or unavailable. It would also be advantageous if this information forum was a centralized data repository where all parties may post and receive their information.

Different parties to a transaction require disparate sets of information. Some information may be confidential and not suitable for distribution to all other interested parties. Accordingly, it would be advantageous to have a system for distributing information that restricts access only to authorized parties.

Transaction communications traditionally have been conducted over wired telephones. However, other methods of communication may be used to supplement or replace wire telephone communication. For example, the Internet may be used to access world-wide-web pages (“web pages”) and these web pages may include databases containing forms. Additionally, party communications may be transmitted via emails from one party to one or more other parties. It would be advantageous to utilize a network such as the Internet as a conduit for accessing data and delivering information. Additionally, it would be advantageous to utilize email messages to facilitate directed communication. It would also be advantageous to utilize web pages as central data repositories that may additionally be capable of transmitting automated email messages, based on transaction party activities within the web pages.

### SUMMARY OF THE INVENTION

The invention disclosed herein utilizes a network, such as the Internet, to access multi-party transaction information. The basic idea is that a web page is used to maintain a collection of documents related to a transaction and regulate access to these documents. In one example, loan officers may utilize the Internet to communicate with real-estate agents, borrowers, and escrow officers via email messages and access to the web page. Because only designated transaction parties would access the same set of documents and only authorized parties may access the web page, miscommunications and mistakes would be dramatically reduced.

The web page includes a central repository for the loan documents such as Conditional Loan Approval, Appraisal, Good Faith Estimate, termite reports, title policies and Settlement Statements and serves as a central point of contact for the authorized transaction parties. Parties to the transaction may track the progress of a loan, review key loan documents, and communicate with other parties so long as they have access to the web page. Access to particular documents or information may be restricted to particular transaction parties to maintain confidentiality. Information is available whenever the web page is accessible, even if parties providing the information are unavailable, away from work, or on vacation. Additionally, the web page may be programmed to generate automated email messages to authorized parties when a document has been posted, updated, or removed from the web page.

While a traditional loan process may require 30-40 telephone calls to keep all parties informed, the instant invention allows loan officers to spend more time on those things that generate new business. For example, real-estate agents will want to work with loan officers that utilize this system to save them time and deliver exceptional service.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is a block diagram of a multi-party transaction management system, according to the invention, including a plurality of access points, a communication network, and a web-page server with an associated data storage medium, said data storage medium including one or more documents, a mutli-party transaction web-page, and an access management algorithm.

FIG. 2 is a block diagram illustrating a log-on web page of the multi-party transaction web-page of FIG. 1.

FIG. 3 is a block diagram of a home web-page linked to the log-on web-page of FIG. 2, including gateways to theme web-pages.

FIG. 4 is a block diagram of a setup theme web-page.

FIG. 5 is a block diagram of a contacts theme web-page, including gateways to derivative web-pages.

FIG. 5A is a block diagram of an add-a-contact derivative web-page.

FIG. 6 is a block diagram of a loans theme web-page, including gateways to derivative web-pages.

FIG. 6A is a block diagram of an add-a-loan derivative web-page.

FIG. 6B is a block diagram of an existing-loan derivative web-page, including information areas and a menu that includes links to subordinate web-pages.

FIG. 6B1 is a block diagram of a loan-information web-page.

FIG. 7 is a flow-chart illustrating the process of creating a multi-party transaction web-page.

FIG. 7A is the flow-chart of FIG. 7 with the added step of posting word-processing documents

FIG. 7B is the flow-chart of FIG. 7 with the added step of sending notifications to designated parties.

### DESCRIPTION OF THE PREFERRED EMBODIMENTS

This invention is based on the idea of utilizing a web page server to manage multi-party transaction information and limit access to this multi-party transaction information. The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (“FPGAs”), application-specific integrated circuits (“ASICs”), complex programmable logic devices (“CPLDs”), programmable logic arrays (“PLAs”), microprocessors, or other similar processing devices.

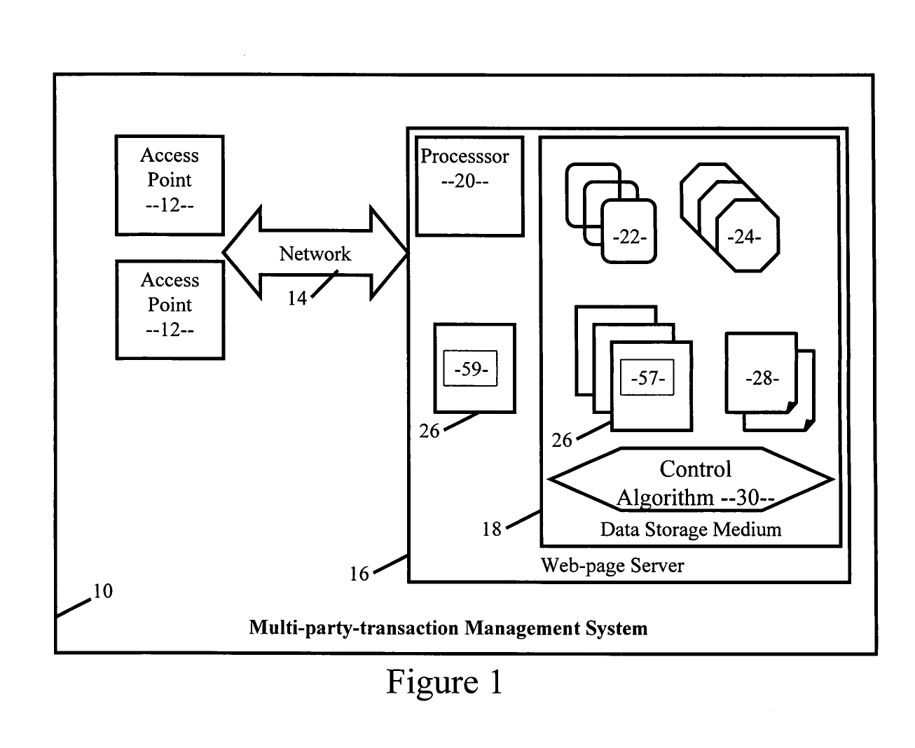

For purposes of clarity, the figures are numbered using an alpha-numeric numbering scheme to illustrate the hierarchical nature of the invention. Referring to figures, wherein like parts are designated with the same reference numerals and symbols, FIG. 1 is a block diagram of a multi-party transaction management system 10 including a plurality of access points 12, a communication network 14, and a web-page server 16. The communication network 14 may include local-area networks (“LANs”), wide-area networks (“WANs”), wireless networks, or bulletin-board systems connected by wired telephones and modems. However, in the preferred embodiment of the invention, the communication network is the Internet.

Access points 12 are interface devices used to access the communication network 14 and communicate with the web-page server 16. These interface devices can be computer terminals, personal computers, personal digital assistants (“PDAs”), or wireless telephones. Any device capable of allowing user input, manipulating and displaying digital information, and transmitting and receiving communications may potentially be adapted to interface with the communication network 14.

The web-page server 16 is a computing device adapted to receive digital information from the communication network 14, store this information in a data storage medium 18, and allow user access to this information through the access points 12 over the communication network 14. A typical web-page server 16 typically would include a computer processing device 20 for managing the flow of information.

The data storage medium may be comprised of an array of redundant hard-disk drives, magneto-optical disk drives, or magnetic tape cartridges. Residing within the data storage medium are software constructs including word-processing documents 22, spreadsheets 24, data bases 26, multi-party transaction web pages 28, and an access management algorithm 30 to restrict access to the documents 22, spreadsheets 24, data bases 26, and web pages 28.

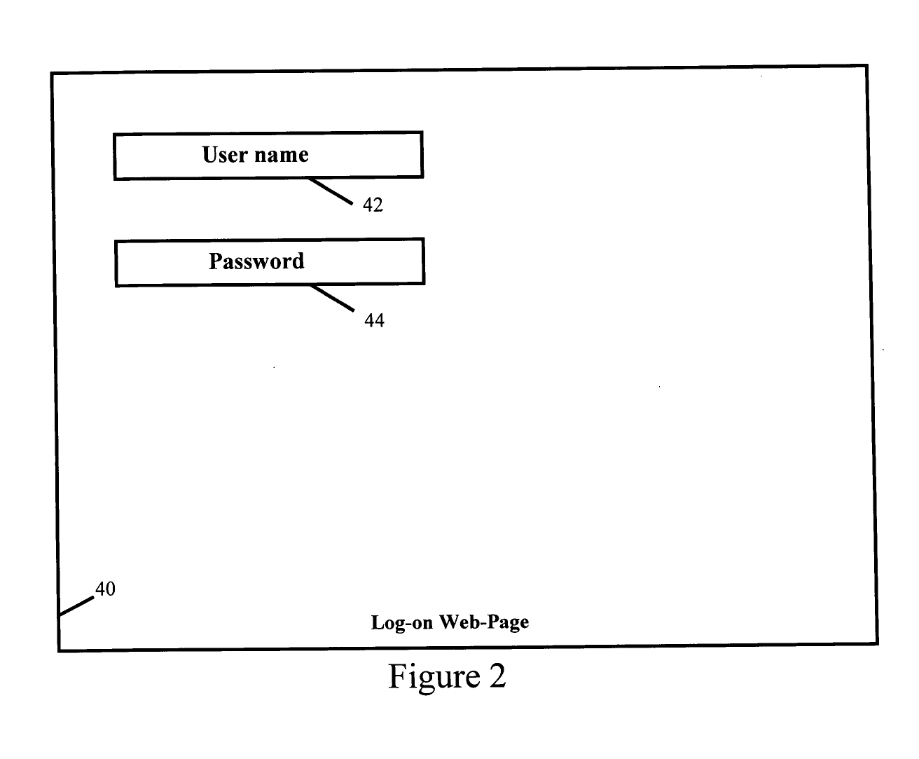

The block diagram of FIG. 2 illustrates a log-on web-page 40 of the multi-party transaction web-page 28 of FIG. 1. The log-on web-page 40 includes a first data-entry area 42 for a user to input his user name. The second data-entry area 44 is used to input the user's password. In a real-estate transaction, the user of the multi-party transaction web-page 28 may be a loan officer, a real-estate agent (including either a listing agent or a selling agent), an escrow agent, or the customer (typically the purchaser/borrower).

If the user is a loan officer, the user name and password are maintained by a system administrator and the individual user. If the multi-party transaction web-page 28 is implemented by a mortgage company or a mortgage brokerage, then an employee of the company/brokerage would provide the loan officer with their user name and password. However, in one embodiment of the invention, the multi-party transaction web-page 28 may be placed on a web-page server 16 administered by the owner or a licensee of the multi-party transaction management system 10 managing accounts from a plurality of individual mortgage companies and brokerages. If, however, the user is a real-estate agent, an escrow agent, or a customer, the log-on information will be provided by the responsible loan officer.

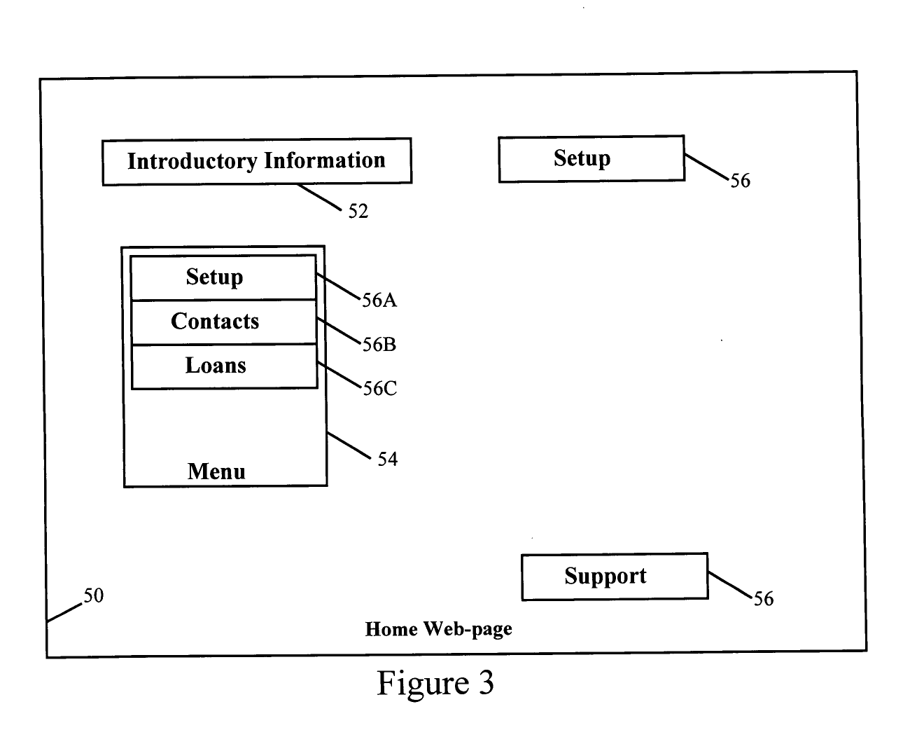

The information entered into the first and second data entry areas 40,42 is matched with information in a database 26 by the access control algorithm 30. A valid match of this information to data stored in the database 26 will close the log-on web-page 40 and initiate the home web-page 50, as illustrated in FIG. 3. The home web-page 50 may include an introductory information area 52 used to introduce users to the multi-party transaction management system 10. In one embodiment of the invention, a user-selectable menu 54 includes a collection of user-selectable locations 56. Alternatively, these user-selectable locations 56 may be placed in various non-associative locations around the home web-page 50.

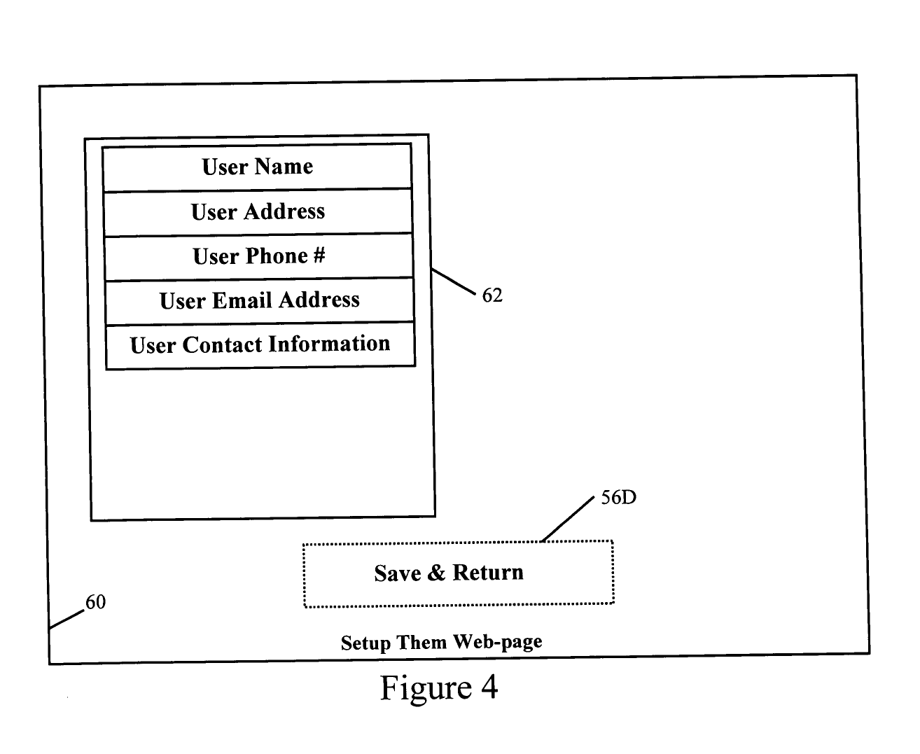

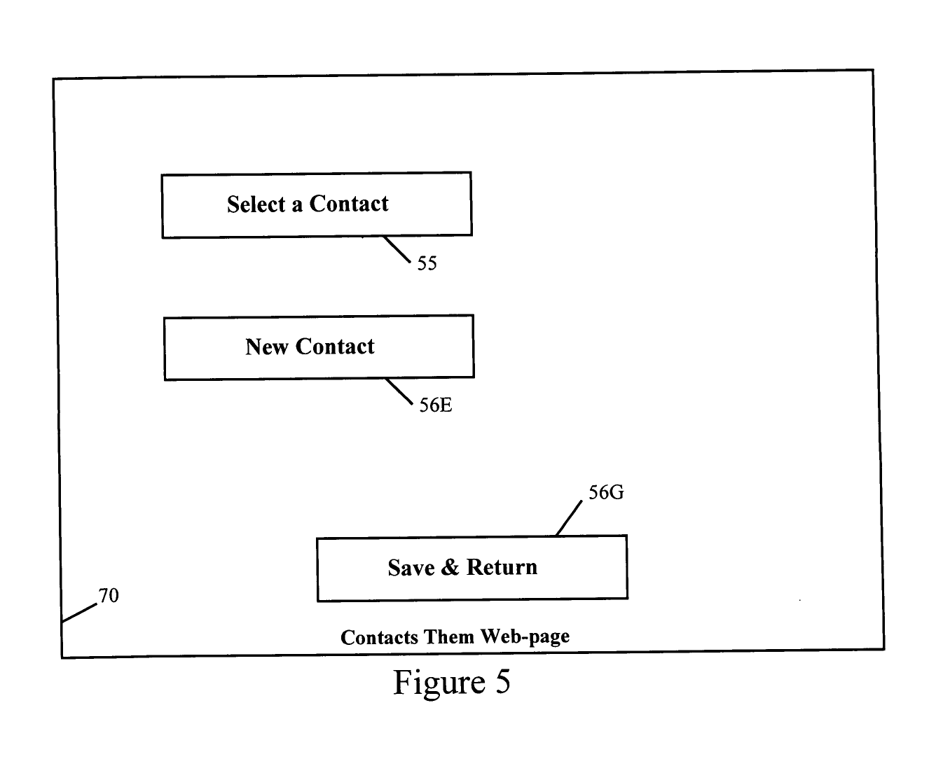

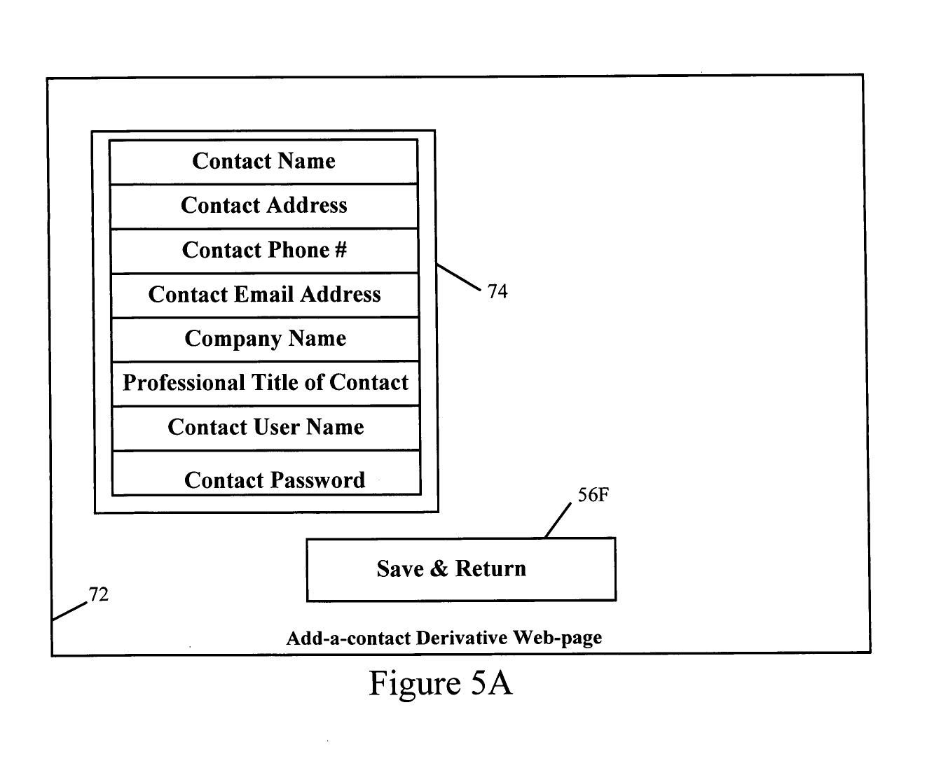

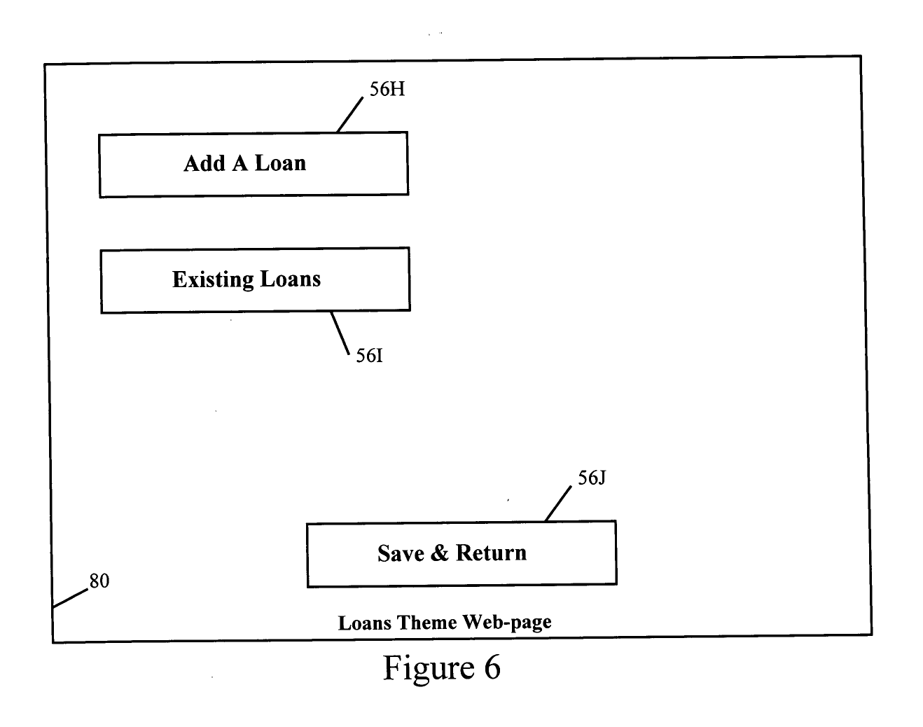

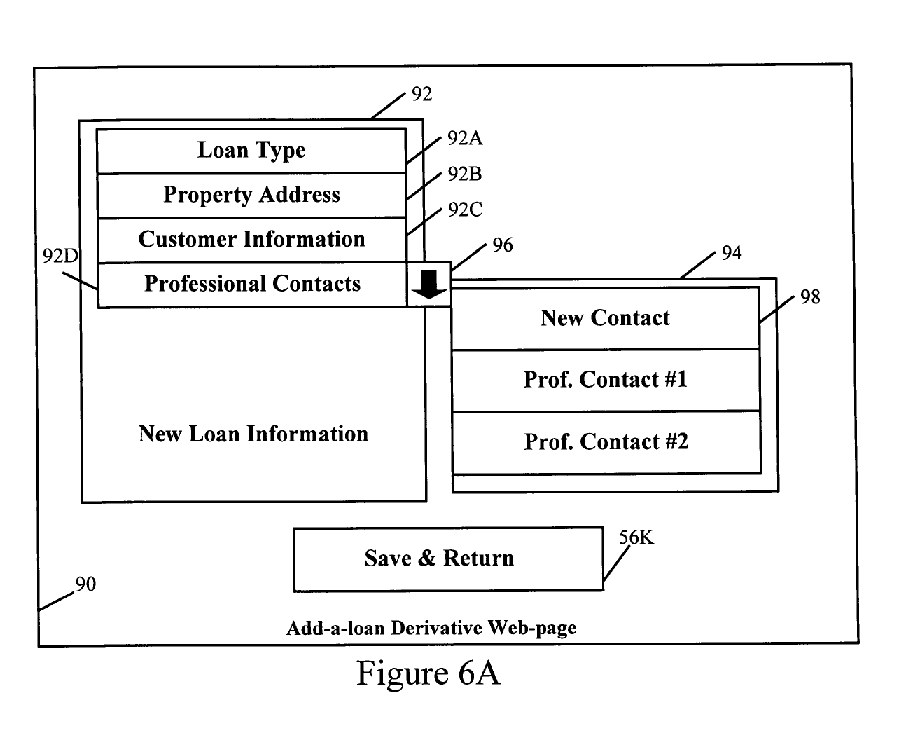

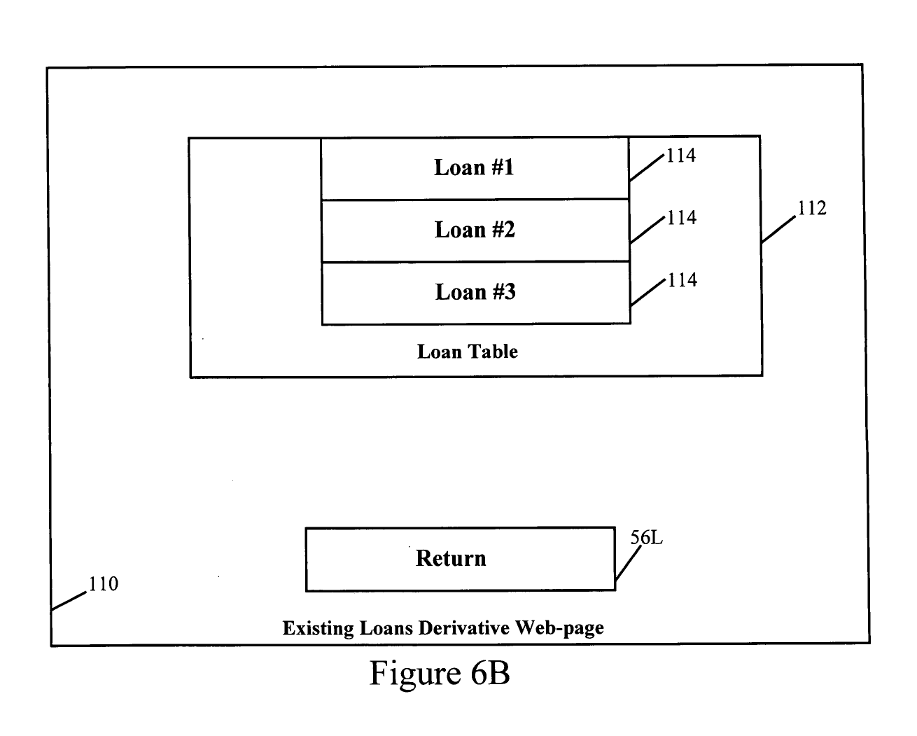

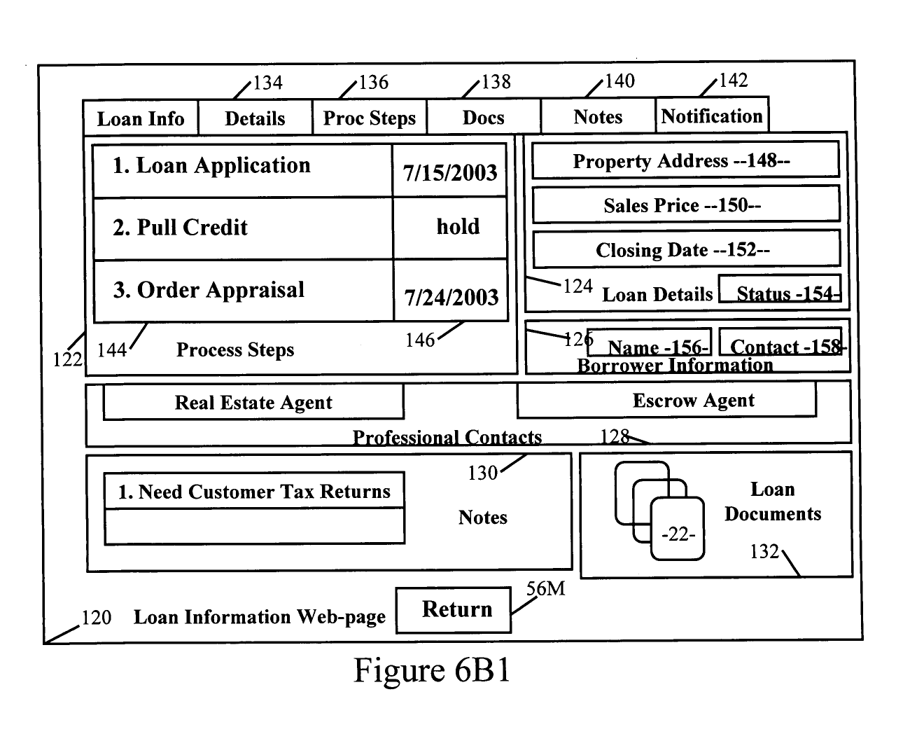

Each user-selectable location 56 is associated with a software instruction that closes the home web-page 50 and initiates an associated theme web-page. For example, the setup user-selectable location 56A will invoke the setup theme web-page (FIG. 4), the contacts user-selectable location 56B will invoke the contacts theme web-page (FIG. 5), and the loans user-selectable location 56C will invoke the loans them web-page (FIG. 6).

Turning the FIG. 4, the setup theme web-page 60 includes setup data-entry areas 62 that allow the user to enter his name, address, phone number, email address, and other contact information. This information is stored in a database 26 and is used by other subsequent users that wish to call the user, send the user an email message, or mail a letter to the user. Additionally, this information may be used to auto-fill forms and documents encountered during the use of the multi-party transaction management system 10.

In this embodiment of the invention, the setup theme web-page 60 includes another user-selectable location 56D, sometimes referred to as a button, to save the database entries, close the setup theme web-page 60, and re-invoke the home web-page 50. When the user has finished entering his contact information, he simply selects the user selectable button 56D which, in turn, closes the setup theme web-page 60 and returns the user to the home web-page 50.

In this embodiment of the invention, once a user has entered his user information into the setup them web-page 60, he may then add contacts to his database 26. These contacts usually include customers, real-estate agents, and escrow agents. Selecting the contacts user-selectable location 56B closes the home web-page 50 and invokes the contacts theme web-page 70, as illustrated in FIG. 5. The user-selectable location 55 allows the user to select a contact from a list of contacts 57 maintained in the database 26 (FIG. 1). If the desired contact is not within the list of contacts 57, then the user must add the contact to the list. The contacts theme web-page 70 typically includes another button or user-selectable location 56E that closes the contacts theme web-page 70 and invokes an add-a-contact derivative web-page 72, as illustrated in FIG. 5A. the add-a-contact derivative web-page 72 includes contact data-entry areas 74 for inputting a contact's name, title, company, physical address, phone number, email address, user name, and password. This user name and password is communicated by the user to the person associated with the contact and may be changed by the contact when they become a user of the multi-party transaction management system. Yet another user-selectable location 56F, stores the contact information in a database 26, closes the add-a-contact derivative web-page 72, and re-invokes the contacts theme web-page 70. When the user is through adding contacts, he may select another user-selectable location 56G to close the contacts theme web-page 70 and re-invoke the home web-page 50 (FIG. 3).

If the user is a loan officer, the loan officer maintains his own list of contacts. Because some users, such as real-estate agents, may work with several loan officers, they should only be established as a contact and given a user name and password once. Otherwise, they would have to use a different user name and password when accessing transactions from different loan officers. Accordingly, when a user such as a loan officer establishes another user such as a real estate agent as a contact, he checks his list of contacts 57 for the contact's name. If the contact is not in the user's list, then the user searches a global contact list 59. If the contact is in the global contact list, the contact's information is copied to the user's list of contacts 57. The eliminates the need for a user to have multiple user names and passwords.

The loans user-selectable location 56C is used to close the home web-page and invoke the loans theme web-page 80, as illustrated in the block diagram of FIG. 6. Here, a user may elect to either create a new loan or edit an existing loan. The user-selectable location 56H is used to close the loans theme web-page 80 and invoke an add-a-loan derivative web-page 90 (FIG. 6A), while an alternate user-selectable location 56I invokes an existing-loans derivative web-page 110 (FIG. 6B).

The add-a-loan derivative web-page 90 includes various loan-information data-entry areas 92 for entering a loan type 92A, property information 92B including physical address, customer information 92C, and professional contacts 92D. Contacts may be selected from a drop-down menu 94 initiated by selecting a drop-down menu button 96. Selecting a new-contact item 98 from the drop-down menu 94 will invoke the contacts theme web-page 70. From this invocation of the contacts theme web-page, selecting the back button 56G will save the new contact information to the database 26, close the contacts them web-page, and return the user to the add-a-loan derivative web-page 90. Selecting the save and close button will save the loan information to the database 26, close the add-a-loan derivative web-page 90 and invoke the loans theme web-page 80.

From the loans theme web-page 80, selecting the existing loans button 56I will close the loans theme web-page 80 and invoke the existing loans derivative web-page 110, as illustrated in FIG. 6B. Loans which have been previously added by the user are listed in a loan table 112. Selecting any indicated loan 114 will close the existing loans derivative web-page 110 and invoke the loan-information web-page 120, as illustrated in the block diagram of FIG. 6B1.

The loan-information web-page includes a process-steps information area 122, a loan-details information area 124, a borrower information area 126, a professional-contacts information area 128, a notes section 130, and a loan documents section 132. Additionally, the loan-information web-page includes a details button 134, a process-steps button 136, a documents button 138, a notes button 140, and a notification button 142. The process-steps information area 122 includes a list of process steps 144 and associated status fields 146. Each status field may contain an indication of progress on the associated process step 144 or a completion date. Process steps 144 are added and modified by selecting the process steps user-selectable area 136 which invokes a database input web-page with data-input fields linked to the database 26.

The loan-details information area 124 may include the physical address of the property 148, the sales price 150, and the projected closing date 152, as entered in the add-a-loan derivative web page 90. Additionally, the loan-details information area 124 may include a transaction status 154. The loan-details information area 124 may be modified by selecting the associated details user-selectable area 134, which invokes another database input web-page linked to the database 26.

The borrower information area 126 may include the name 156 of the customer and contact information 158, as input into the database 26 from the add-a-loan derivative web-page 90. The professional-contacts information area 128 displays contact information entered into the database 26 from the add-a-contact derivative web page 72 and selected on the add-a-loan derivative web page 90.

The notes section 130 is a textual display area intended to display notes and reminders written by the user for the benefit of the user or other transaction parties. The notes section 130 is modified by selecting the notes button 140, which invokes an associated database input web-page linked to the database 26. The loan documents section 132 is a visual representation of word-processing documents that have been associated with, i.e., posted to, this multi-party transaction web-page 28. Selecting the documents button 138 invokes a file-association web-page that allows the user to enter the file name of the documents and the source location of the document. Once selected, the document is copied to the word-processing documents area 22 (FIG. 1) of the data storage medium 18.

Selecting the notification user-selectable area 142 invokes a text-entry area and a menu of potential recipients of the notification. Only those parties that are associated with this particular multi-party transaction web-page, i.e., customer, real-estate agents, escrow agents, and loan officers, are listed in the menu of potential recipients. The user may select any or all of the parties listed in the menu and the textual message will be transmitted to them. If the user has provided an email address for a party, then the message will be transmitted by email. However, if no email is provided or if another method of delivery is preferred, the notification may be transmitted by an alternate form of communications, such as fax or regular mail.

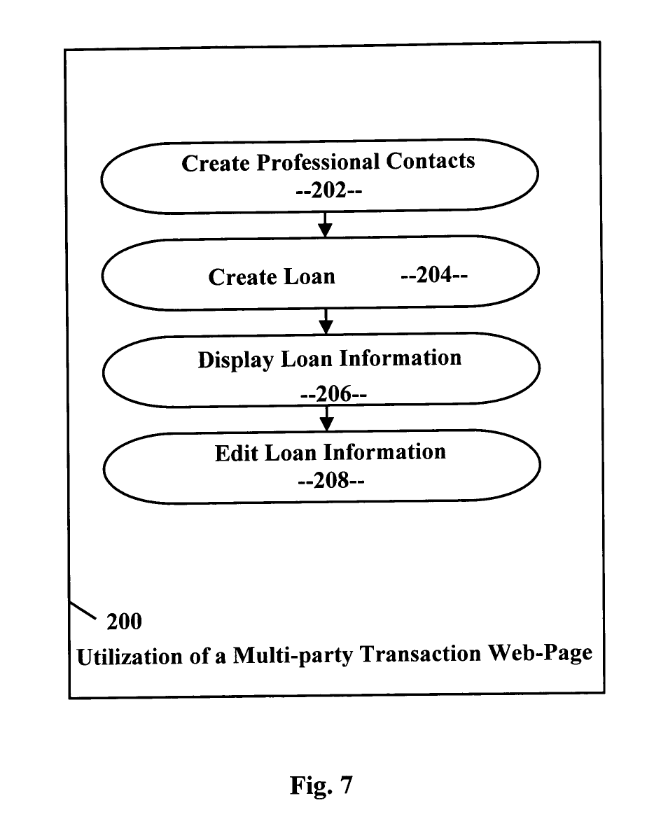

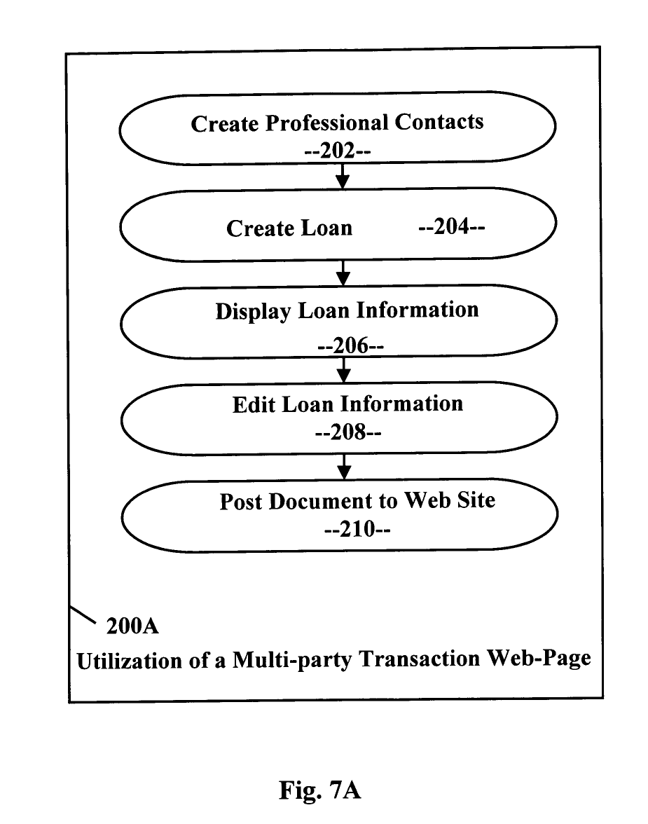

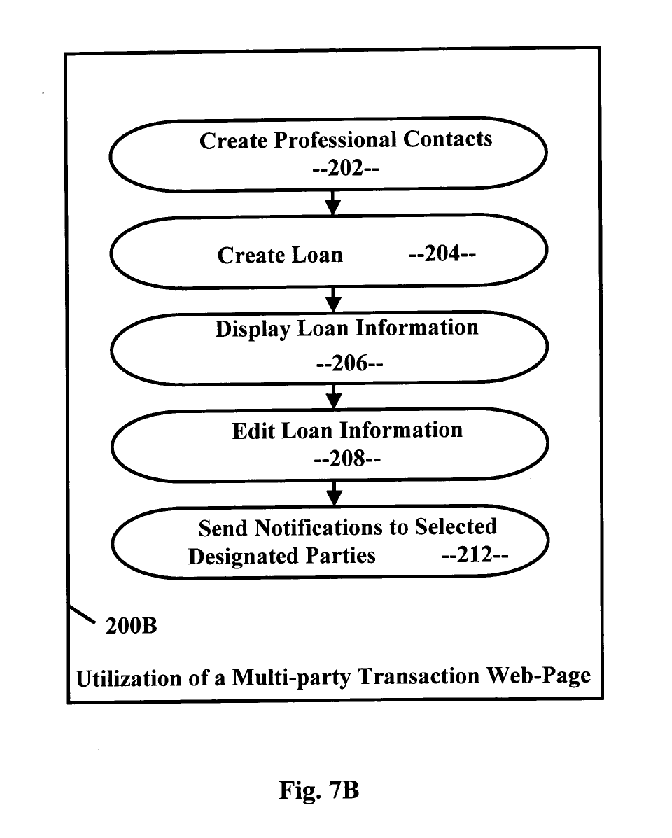

FIG. 7 is a flow-chart illustrating the utilization of a multi-party transaction web-page algorithm 200. A user enters information regarding professional contacts, such as real-estate agents and escrow agents, in data-entry fields of an add-a-contact derivative web-page 72 and this information is saved to a database 26 in step 202. In step 204, the user enters basic loan information, including mortgage type, closing date, closing price, physical address, professional contacts, and customer information, into an add-a-loan derivative web page 90, also associated with the database 26. Only those parties that are indicated in step 204 may access the resulting multi-party transaction web-page 28. Loan information may be viewed by all parties indicated in step 206 by displaying a loan-information web-page 120 which derives data for display from the database 26. Loan information may be changed or added to by the user or indicated parties with authorized access in step 208.

The algorithm 200A illustrated by FIG. 7A is the flow-chart of FIG. 7 with the added step 210 of posting a word-processing document 22 to the multi-party transaction web-page 28. The algorithm 200B of FIG. 7B is the flow-chart of FIG. 7 with the additional step 212 of selectively sending notifications to selected parties taken from the group of authorized parties. These notifications may be by email, fax, or regular mail.

Those skilled in the art of making multi-party transaction information access systems may develop other embodiments of the present invention. For example, a wireless local-area-network may be utilized as the network connecting users to the web page server. Additionally, other forms of transmitting notifications may be used, or loan information may be saved in data-structures other than a database. However, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. A method of using a multi-party transaction web-page, comprising the steps of:
entering a loan officer's contact information into the multi-party transaction web-page;
saving the loan officer's contact information to a database;
entering real-estate transaction information into the multi-party transaction web-page;
saving the real-estate transaction information to the database; and
allowing a first designated party to view said real-estate transaction information and said loan officer's contact information.

2. The method of claim 1, further including the step of entering a real-estate agent's contact information into the multi-party transaction web-page following the step of saving the loan officer's contact information to a database.

3. The method of claim 2, further including the step of saving the real-estate agent's contact information to the user's contact list.

4. The method of claim 1, further including the step of retrieving a real-estate agent's contact information from a global contact list if the real-estate agent's contact information already resides within the database.

5. The method of claim 1, wherein the first designated party is a real-estate agent.

6. The method of claim 1, wherein said real-estate transaction information includes a loan document.

7. The method of claim 1, further comprising the step of editing said real-estate transaction information.

8. The method of claim 1, further comprising the step of transmitting notifications from the first designated party to a second designated party.

9. The method of claim 5, further comprising the step of transmitting notifications from the real-estate agent to a borrower.

10. The method of claim 1, wherein the first designated party is an escrow agent.

11. The method of claim 1, wherein the first designated party is a borrower.

12. The method of claim 1, further comprising the step of adding saving notes to the database.

13. A method of using a multi-party transaction web-page, comprising the steps of:
entering contact information into an electronic data structure;
entering multi-party transaction information into the electronic data structure; and
allowing a first designated party to view said multi-party transaction information and said contact information.

14. The method of claim 11, wherein said data structure is a database.

15. The method of claim 11, wherein said multi-party-transaction information includes an electronic document.

16. The method of claim 11, further comprising the step of editing said multi-party-transaction information.

17. The method of claim 11, further comprising the step of transmitting notifications from the first designated party to a second designated party.

18. The method of claim 11, further comprising the step of posting an electronic document to said electronic data structure.

19. The method of claim 11, further comprising the step of adding notes to the electronic data structure.

20. A multi-party-transaction information-access system, comprising:
an access point;
a communication network; and
a web-page server, said web-page server including a data storage medium, said data storage medium including a data structure adapted to store multi-party-transaction information; wherein said web-page server is adapted to display said multi-party-transaction information only to designated parties.

21. The multi-party-transaction information-access system of claim 20, wherein said data structure is a database.

22. The multi-party-transaction information-access system of claim 20, wherein said multi-party-transaction information includes an electronic document.

23. The multi-party-transaction information-access system of claim 20, wherein said multi-party-transaction information may be edited by one of the designated parties.

24. The multi-party-transaction information-access system of claim 20, wherein notifications may be transmitted only to one or more of the designated parties.

25. The multi-party-transaction information-access system of claim 20, wherein one or more designated parties may post a document to said data structure.

26. The multi-party-transaction information-access system of claim 20, wherein said multi-party-transaction information includes process steps.

27. The multi-party-transaction information-access system of claim 20, wherein said multi-party-transaction information includes notes that may be viewed by the designated parties.

28. The multi-party-transaction information-access system of claim 20, wherein said multi-party-transaction information includes loan information.

29. A multi-party transaction web-page, comprising:
a contacts web-page adapted to allow a user to enter contact information into an electronic data structure;
a transaction data-entry web-page adapted to allow the user to enter multi-party transaction information into the electronic data structure; and
a transaction information display web-page adapted to allow a first designated party to view said multi-party transaction information and said contact information.

30. The multi-party transaction web-page of claim 29, wherein said electronic data structure is a database.

31. The multi-party transaction web-page of claim 29, wherein said multi-party-transaction information includes a document.

32. The multi-party transaction web-page of claim 29, wherein said multi-party-transaction information may be edited by the first designated party.

33. The multi-party transaction web-page of claim 29, wherein notifications may be transmitted by the first designated party to a second designated party.

34. The multi-party transaction web-page of claim 29, wherein the first designated party may post a document to said data structure.

35. The multi-party transaction web-page of claim 29, wherein said multi-party-transaction information includes process steps.

36. The multi-party transaction web-page of claim 29, wherein said multi-party-transaction information includes notes that may be viewed by either the first designated party or the second designated party.

37. The multi-party transaction web-page of claim 29, wherein said multi-party-transaction information includes loan information.
